(19) United States
(12) Patent Application Publication
(10) Pub. No.: US 2026/0221766 A1
(43) Pub. Date: Jul. 30, 2026

(54) CLONING OF LARGE-SCALE POWER TRANSMISSION SYSTEMS FOR TRANSIENT STATE ANALYSIS EQUIVALENCY

(71) Applicant: SAUDI ARABIAN OIL COMPANY, Dhahran (SA)

(72) Inventor: Joseph Letèf, Dhahran (SA)

(73) Assignee: SAUDI ARABIAN OIL COMPANY, Dhahran (SA)

(21) Appl. No.: 19/039,310

(22) Filed: Jan. 28, 2025

(51) Int. Cl. H02J 3/00

(52) U.S. Cl. CPC H02J 3/001; H02J 2103/30

(57) ABSTRACT

A method for reducing complexity of a power system includes performing frequency scans of zero and positive sequence impedances on the power system at a bus and plotting magnitudes and imaginary parts of the zero and positive sequence impedances of the power system at the bus. The method further includes extracting the magnitudes and phases of the zero and positive sequence impedances from the plot and configuring a resistor, inductor, and capacitor (RLC) equivalent system with one or more resistors, inductors, and capacitors in parallel to replicate characteristics of the plot. The method further includes computing values of the one or more resistors, inductors, and capacitors at one or more resonant frequency poles from the plot; and connecting the computed values into the RLC equivalent system at the bus.

### BACKGROUND

The power transmission system of major companies has seen significant growth over the past decade. The complexity and necessity for accurate system modeling and power system studies, including steady state and transient state analyses, have become increasingly demanding. Simulation results, accompanied by technical recommendations, are crucial for defining and refining the scope of work (SOW) during the detailed design phase, especially for large-scale Power Transmission Systems projects that involve integration with, and between, the company's system and a National Grid. Power system interconnection studies require comprehensive transmission system data from both entities, even though these studies are now conducted using advanced simulation tools such as Power System Simulator for Engineering (PSSE), Electrical Transient Analysis Program (ETAP), Power System Computer Aided Design (PSCAD), and Electromagnetic Transient Program-Restructured Version (EMTP-RV), which may be employed by both the National Grid and the company. Cloning large-scale power transmission systems has become essential and advantageous for both parties.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for reducing complexity of a power system. This method is developed in order to reduce the size of power systems models, enabling proper and adequate system equivalency and provide compact transmission system input data, all required for transient simulation studies, while preserving acceptable results between the two models. The steady states of the complex network are preserved by controlling the voltage, phase angle and the power injected at the equivalent bus bar. Furthermore, the frequency dependent network impedances of positive and zero sequences spectrums, are used to estimate and calculate the equivalent resistor, inductor, and capacitor (RLC) in parallel at each pole, as such reflecting the behaviors during an electromagnetic transient disturbance. A validation between the large large-scale Power Transmission Systems and the reduced equivalency are further included in this method.

In general, in one aspect, embodiments relate to a method for reducing complexity of a power system. When the power system is in a steady state, the method includes computing Thevenin equivalent impedance values at a system frequency; and transforming the power system into its Thevenin equivalent system at a first bus, and validating parameters at the first bus to ensure the Thevenin equivalent system matches the power system.

In general, in one aspect, embodiments relate to a method for reducing complexity of a power system. When the power system is in a transient state, the method includes performing frequency scans of zero and positive sequences on the power system at a second bus and plotting magnitudes and imaginary parts of the zero and positive sequence impedances of the power system at the second bus. The method further includes extracting the magnitudes and phases of the zero and positive sequence impedances from the plot and configuring RLC equivalent system with one or more resistors, inductors, and capacitors in parallel to replicate characteristics of the plot. The method further includes computing values of the one or more resistors, inductors, and capacitors at one or more resonant frequency poles from the plot and connecting the computed values into the RLC equivalent system at the second bus. The method further includes validating parameters at the second bus to ensure the RLC equivalent system matches the power system. When validation fails, steps of computing the values of R, L, and C and connecting the computed R, L, C values may be repeated.

Other aspects and advantages of the invention will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a steady state reduced model in accordance with various embodiments;

FIG. 2 shows a frequency scan in accordance with various embodiments;

FIG. 3 shows a Bell shape spectrum of RLC in parallel in accordance with various embodiments;

FIG. 4 shows RLC in parallel at each selected pole in accordance with various embodiments;

FIG. 5 shows Magnitude of Z₀ & Z₁ Frequency scan spectrum in accordance with various embodiments;

FIG. 6 shows Phase of Z₀ & Z₁ (imaginary) Frequency scan spectrum in accordance with various embodiments;

FIG. 7 shows a reduced network in accordance with various embodiments;

FIG. 8 shows different types of overvoltage events;

FIG. 9 shows various shapes of overvoltages;

FIG. 10 shows examples of common switching transient phenomena;

FIG. 11 shows a method in accordance with various embodiments;

FIG. 12 shows a method in accordance with various embodiments;

FIG. 13 shows a system in accordance with various embodiments.

### DETAILED DESCRIPTION

Specific embodiments of the invention will now be described in detail with reference to the accompanying figures. Like elements in the various figures are denoted by like reference numerals for consistency. Like elements may not be labeled in all figures for the sake of simplicity.

In the following detailed description of embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that, one or more of the steps shown in the flowcharts may be omitted, repeated, and/or performed in a different order than the order shown. Accordingly, the scope of the invention should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

In general, embodiments of this disclosure include methods designed to reduce the size of power system models. These methods facilitate accurate and adequate system equivalency, enabling the creation of compact transmission system input data necessary for transient state simulation studies, while maintaining acceptable consistency between the results of the large-scale and reduced models of power transmission systems.

Currently, only the steady-state 60 Hz Thevenin equivalent impedance (Z1, Z2, and Z0) is being utilized for simulations of both steady-state and transient-state conditions. However, this Thevenin equivalent impedance is valid solely for steady-state studies because the values of Z1, Z2, and Z0 are computed at 60 Hz, based on the net short-circuit values at the equivalency bus for three-phase faults, single-phase-to-ground faults, and their corresponding X/R ratios (X1/R1 and X0/R0). The steady-state equations for Z1, Z2, and Z0 are provided below. Note that these steady-state values of Z1 and Z0 are typically not used for transient-state simulations. Instead, a frequency-dependent model for Z1, Z2, and Z0 is required, both in magnitude and phase, to accurately reflect behavior during an electromagnetic transient disturbance.

Embodiments of FIG. 1 are directed to a simplified equivalent circuit for steady state systems. The steady-state Thevenin equivalent impedance values, Z1 and Z0, may be computed at either 60 Hz or 50 Hz, depending on the system, based on the net short-circuit values at the equivalency bus for three-phase faults and single-phase-to-ground faults, along with the corresponding X/R ratios (X1/R1 and X0/R0). The equations for Z1 and Z0 are provided below.

$$Z 1 = \frac{{V}_{ph - ph}}{\sqrt{3} {I}_{3 ϕ\_ SOURCE}} \qquad ( 1 )$$

$${Z 0}_{total} = \frac{\sqrt{3} {V}_{ph - ph}}{3 {I}_{0 \_ TOTAL}} - 2 ( \frac{{V}_{ph - ph}}{\sqrt{3} {I}_{3 ϕ\_ TOTAL}} ) \qquad ( 2 )$$

$${Z 0}_{total} = \frac{3 {I}_{0 \_ TOTAL}}{3 {I}_{0 \_ SOURCE}} {Z 0}_{total} \qquad ( 3 )$$

In equation (1), the positive-sequence impedance Z1 is calculated by dividing the phase-to-phase voltage by the product of the square root of 3 and the source current. Z1 represents the positive-sequence impedance of the power system. Vₚₕ₋ₚₕ is the line-to-line voltage (also known as phase-to-phase voltage). I_{3φ_SOURCE} represents the total current for the three-phase system coming from the source.

In equation (2), the total zero-sequence impedance Z0ₜₒₜₐₗ is calculated.

In equation (3), the source-side zero-sequence impedance Z0_{source} is calculated.

Continuing with FIG. 1, embodiments disclosed herein may simplify the analysis of a power system by replacing a complex network of generators, transformers, and transmission lines based on calculated impedance values.

For example, Vi∠δi in FIG. 1 represents the voltage at the internal bus (or the source bus) of the power system. The voltage is denoted by Vᵢ and has a phase angle δᵢ. This is typically the point where the internal generator or source voltage may be considered. Z∠φ_{Z} represents the Thevenin equivalent impedance of the system between the internal bus and the external bus where the equivalency is needed. The impedance Z has both a magnitude and phase angle φ. This impedance accounts for the effects of the network elements between the internal generator and the bus where the analysis is focused.

In one or more embodiments, the following equations may be used for determining the relationships between internal and external voltages within the system, considering the effects of system impedance, power flow, and phase angles.

$$δ = φ - arctan ( \frac{P + \frac{{V}_{ext}^{2}}{Z} cos ( φ )}{Q + \frac{{V}_{ext}^{2}}{Z} sin ( φ )} )$$

$${δ}_{i} = {δ}_{ext} + δ$$

$${V}_{i} = ( Q + \frac{{V}_{ext}^{2}}{Z} sin ( φ ) ) \frac{Z}{{V}_{ext} sin ( φ - δ )}$$

φ=Impedance angle
δ=Angle between Vᵢ et Vₑₓₜ
Vᵢ=Internal Voltage ph—ph rms
Vₑₓₜ=External voltage ph—ph rms
P & Q=Active and Reactive power
Vₑₓₜ & δₑₓₜ=Voltage magnitude & Phase

Embodiments disclosed herein also relate to validation, which is essential between the large-scale transmission system and the reduced model at the equivalency bus. This process ensures that the results from both the full-scale and reduced models align satisfactorily when compared. The validation process is considered successful if the difference in results between the two models is, for example, 5% or less. One or more key parameters to validate may include:
a) Voltage Magnitude and Phase: Ensuring that the voltage magnitude and phase angles are consistent between the two models at the equivalency bus;
b) Three-Phase and Single-Phase Faults (kA): Verifying that the fault currents for three-phase faults and single-phase-to-ground faults match within the acceptable difference at the equivalency bus; and
c) Active and Reactive Power and Flow Directions (±MW, ±Mvars): Confirming that the active and reactive power values, along with their flow directions, are consistent between the large-scale system and the reduced model. This includes ensuring the correct alignment of power flows, whether positive or negative, in both models.

However, the steady-state equivalent, calculated at 60 Hz or 50 Hz, may be insufficient for analyzing electromagnetic transient phenomena, which involve high-frequency spectra such as temporary or switching overvoltages, inrush transients, harmonic phenomena, and more.

In one or more embodiments, a power system can transition between transient and steady states. For example, after a disturbance like a fault, switching event, or load change, the system enters a transient state, characterized by short-term fluctuations in voltage, current, or frequency. These oscillations gradually decay as the system stabilizes, eventually reaching a steady state, where variables like voltage and current maintain consistent values over time. Similarly, a system can move from a steady state to a transient state if a new disturbance occurs, disrupting the stability of the system.

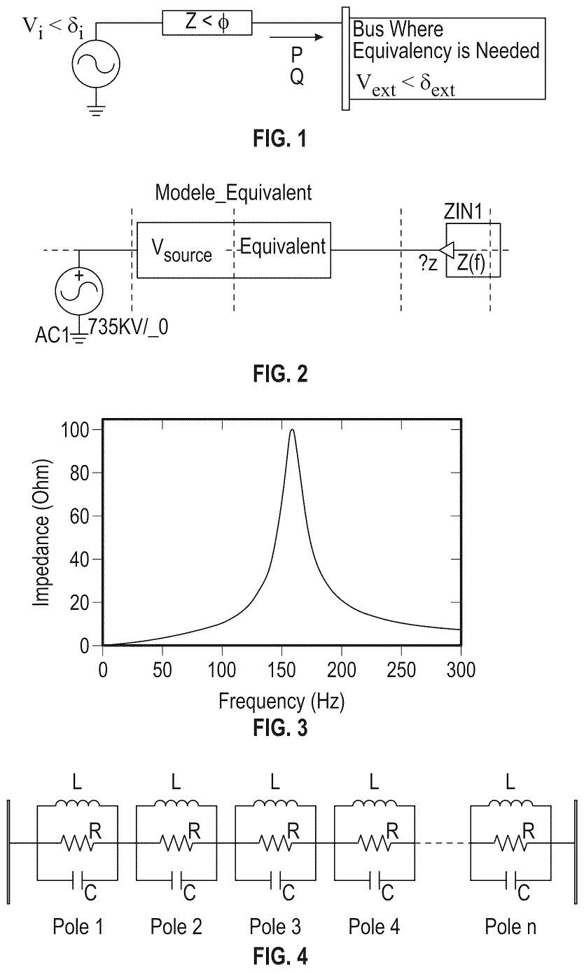

According to FIG. 2, one or more embodiments include performing frequency scans of zero and positive sequences on the large-scale transmission network at the bus where the equivalency is needed. This process provides an accurate representation of the frequency responses of the integrated network in the transient state system, and may aid in determining how impedance varies with frequency, which may be advantageous for accurate transient state analysis.

As shown in FIG. 2, Z(f) denotes the frequency-dependent impedance. The impedance varies with frequency and is crucial for understanding the network's response to transient events, which involve different frequencies. ZIN1 represents the input impedance at a specific bus where the frequency scan is being performed.

The magnitudes and imaginary components of the zero sequence impedance Z0(f) and the positive sequence impedance Z1(f) of the large-scale transmission network may be plotted at the equivalency bus. These plots may be advantageous for analyzing the network's frequency-dependent behavior.

Based on the plots, the magnitudes |Z0|(f) and |Z1|(f) of the zero and positive sequence impedances are extracted. The phase angles ∠φ_{Z0} and ∠φ_{Z1} associated with these impedances are also determined.

As such, an equivalent network comprising a resistor (R), inductor (L), and capacitor (C) arranged in parallel may be used to model the frequency-dependent behavior observed in the large-scale transmission network.

The RLC components are calculated to replicate the “bell-shaped” characteristics that are observed in the frequency response of the large-scale network. This shape typically encompasses the various resonant poles within the electrical network.

The calculated RLC parameters are selected to match the frequency response, including the magnitudes and phases of the zero and positive sequence impedances |Z0|(f) and |Z1|(f), and associated phase angles ∠φ_{Z0} and ∠φ_{Z1}.

By representing the complex frequency-dependent behavior of the original network with an equivalent RLC circuit, the reduced model can accurately simulate the network's response during transient events, such as switching transients and harmonic phenomena. This ensures that the reduced model preserves the key characteristics of the large-scale system, making it suitable for detailed transient analysis.

The “bell-shaped” characteristics may be shown in FIG. 3. Embodiments of FIG. 3 illustrate a bell-shaped spectrum, which is characteristic of an RLC circuit with the RLC arranged in parallel. The X-axis represents the frequency (in Hz) at which the impedance is measured, ranging from lower to higher frequencies. The Y-axis represents impedance magnitude (in Ohms) of the circuit at different frequencies. This curve, shaped like a bell, indicates a peak impedance at specific resonant frequencies, followed by a decline as the frequency moves away from the resonance. This bell-shaped spectrum is typical of resonant circuits, where the impedance reaches a peak at a specific resonant frequency, followed by a decline on either side of this peak as the frequency shifts away from resonance.

In one or more embodiments, the values of the resistor (R), inductor (L), and capacitor (C) at each resonant pole may be calculated based on the “bell-shaped” spectrum obtained from the frequency response analysis. These values are derived using equations that correspond to the characteristics of the plotted waveform spectrum.

In one or more embodiments, the equations may include:

$${R}_{n} = \vert {Z}_{n} ( {f}_{n 0} ) \vert$$

$${L}_{n} = \frac{{R}_{n} \times ( {f}_{n - Xmin} - {f}_{n - Xmax} )}{2 π \times ( {f}_{n - Xmin} - {f}_{n - Xmax} )}$$

$${k}_{n} = 4 {π}^{2} \times ( {f}_{n - Xmin} \times {f}_{n - Xmax} )$$

$${C}_{n} = \frac{1}{{k}_{n} \times {L}_{n}}$$

The equations are used to calculate the R, L, and C at each resonant pole of the system's impedance. These values are derived from the plotted waveform spectrum of the system's impedance response, particularly focusing on the zero-sequence Z₀(f) and positive-sequence Z₁(f) impedance curves.

$$f ( {n}_{X} ) = \frac{1}{2 \times π \sqrt{{L}_{n} \times {C}_{n}}}$$

represents the resonance frequency for the nth pole, where Lₙ and Cₙ are the inductance and capacitance, respectively. The resonance frequency corresponds to the frequency at which the RLC circuit exhibits maximum impedance.

Rₙ represents the magnitude of the nth pole of the impedance Z₀(f) for the zero sequence or Z₁(f) for the positive sequence.

f_{n-Xmax} represents the frequency at which the imaginary part of the impedance, X₀ (for the zero sequence) or X₁ (for the positive sequence), reaches its maximum value, corresponding to an inductive response denoted as L₀ or L₁.

f_{n-Xmin} represents the frequency at which the imaginary part of the impedance, X0 (for the zero sequence) or X1 (for the positive sequence), reaches its minimum value, corresponding to a capacitive response denoted as C₀ or C₁.

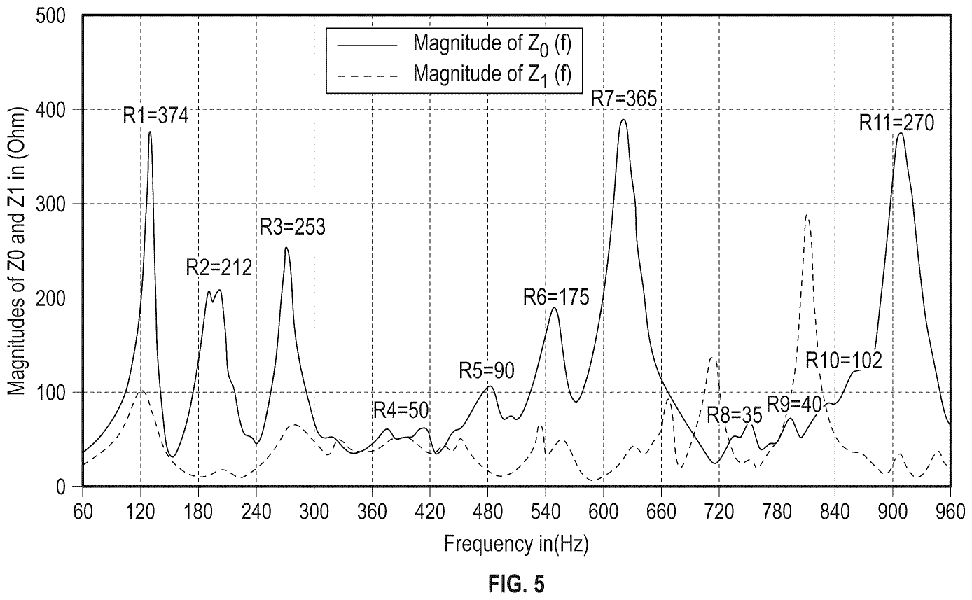

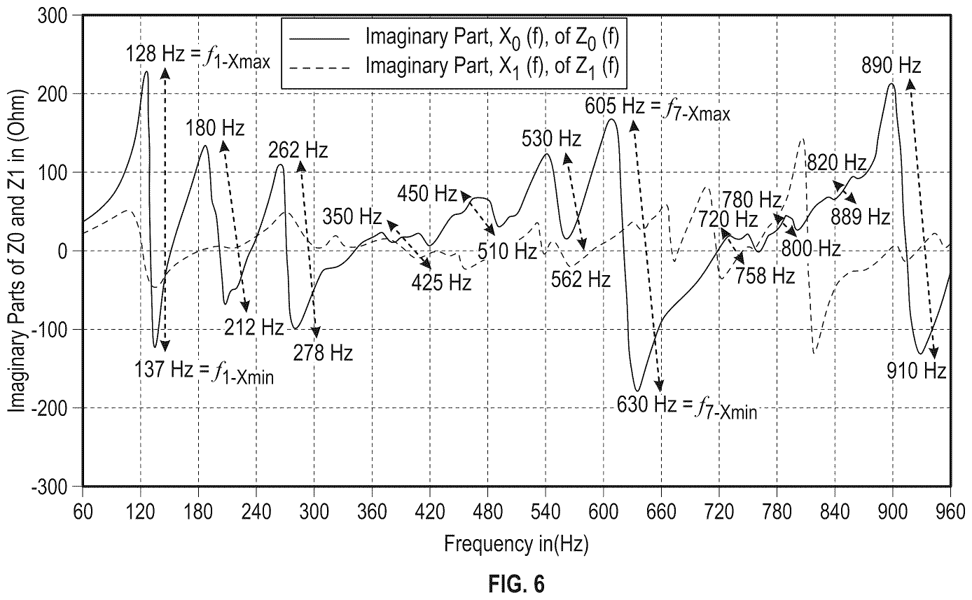

By applying these equations with the impedance waveform data of, for example, FIGS. 5 and 6, the values for the R, L, and C at each resonant frequency may be calculated. These RLC parameters are derived from the frequencies where the impedance reaches its maximum and minimum values, and therefore are critical for constructing an equivalent model that can accurately simulate the transient and frequency-dependent behavior of the large-scale power system.

To better understand how these calculated values of resistance, inductance, and capacitance are applied, FIG. 4 illustrates embodiments of the configuration of RLC circuits in parallel at each resonant pole by visually representing the system's frequency-dependent behavior as derived from the previous equations.

FIG. 4 shows embodiments of RLC in parallel at each selected pole. Each pole corresponds to a specific resonant frequency in the impedance spectrum of the system, and the parallel RLC network at each pole may include an R, L, and C. The parallel RLC circuit at each pole mimics the behavior of the impedance at that frequency.

FIG. 5 illustrates the magnitude spectrum of Z₀ and Z₁ from a frequency scan. More specifically, FIG. 5 shows the frequency scan spectrum of the zero-sequence Z₀(f) and positive-sequence Z₁(f) impedances across a range of frequencies. The solid line curve represents Z₀(f) and the dashed line curve represents Z₁(f), with multiple resonant peaks labeled by their corresponding resistance values at specific frequencies. These peaks indicate the points where the impedance magnitude is highest and reflect the system's response to different frequencies.

FIG. 6 illustrates the imaginary parts of the zero-sequence Z₀(f) and positive-sequence Z₁(f) impedances as a function of frequency, highlighting the phase behavior of both sequences. The solid line curve represents X0(f), the imaginary part of Z₀(f), while the dashed line curve represents X1(f), the imaginary part of Z₁(f). Key resonant points are labeled along the frequency axis. These points demonstrate where the system transitions between inductive and capacitive behavior across the frequency spectrum.

Based on the above FIGS. 5 and 6, the following table presents an example of the computed values of resistance, inductance, and capacitance for each resonant pole, corresponding to different frequencies in the system's impedance spectrum.

| Fn-Xmax | Fn-Xmin | Rn | POLE | R (Ohm) | L (H) | C (F) |
|---|---|---|---|---|---|---|
| 128 | 137 | 374 | 1 | 374 | 0.0305494719 | 0.00004728311 |
| 180 | 212 | 212 | 2 | 212 | 0.0282942121 | 0.00002346034 |
| 262 | 278 | 253 | 3 | 253 | 0.0088453403 | 0.00003931693 |
| 350 | 425 | 50 | 4 | 50 | 0.0040123095 | 0.00004244132 |
| 450 | 510 | 90 | 5 | 90 | 0.0037448222 | 0.00002947314 |
| 530 | 562 | 175 | 6 | 175 | 0.0029922369 | 0.00002842053 |
| 605 | 630 | 365 | 7 | 365 | 0.0038102817 | 0.00001744164 |
| 720 | 758 | 35 | 8 | 35 | 0.0003878556 | 0.00011966537 |
| 780 | 800 | 40 | 9 | 40 | 0.0002040448 | 0.00019894368 |
| 820 | 889 | 102 | 10 | 102 | 0.0015365751 | 0.00002261366 |
| 890 | 910 | 270 | 11 | 270 | 0.0010611640 | 0.00002947314 |

Each row represents a specific pole, with its associated frequency and the calculated R, L, and C values, reflecting the system's behavior at that frequency. As shown in FIG. 6, Fn-Xmax corresponds to the frequencies where the imaginary parts of Z₀(f) or Z₁(f) are at a maximum, which indicates the system's inductive peaks. Similarly, as shown in FIG. 6, Fn-Xmin corresponds to the frequencies where the imaginary parts are at a minimum, which reflects the points of maximum capacitive behavior. These specific frequencies are used to calculate the RLC parameters for the system at each pole. By referencing the peaks and troughs in FIGS. 5 and 6, the exact frequencies for inductive and capacitive extremes can be identified.

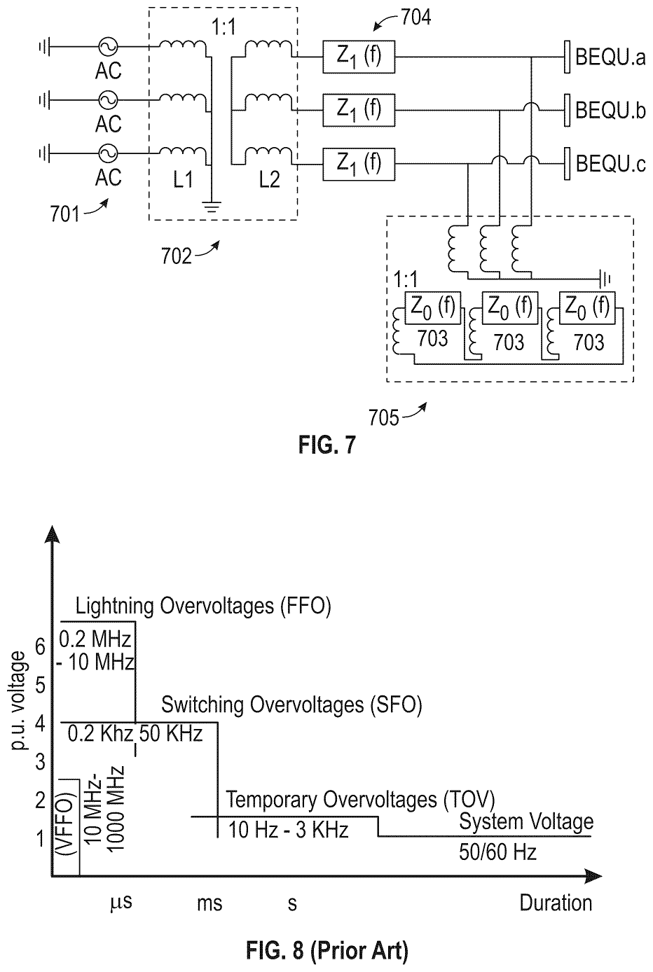

Continuing with the previously calculated RLC values for each resonant pole, FIG. 7 illustrates connecting the resistors, inductors, and capacitors with the computed values into the RLC equivalent system.

In one or more embodiments, the RLC equivalents, calculated for each resonant pole, may be connected into the reduced model via 1:1 transformers to ensure that the reduced network accurately replicates the frequency-dependent behavior of the original larger network. This allows the reduced model to exhibit the same inductive and capacitive responses as the full-scale system.

Specifically, according to one or more embodiments, FIG. 7 shows a simplified representation of an electrical system where the three-phase input from the electrical grid 701 (depicted by the three waveforms) flows through 1:1 transformers 702 to transfer the system's impedance characteristics to a reduced equivalent model. These transformers ensure that the reduced model accurately mimics the behavior of the full grid system at the equivalency bus. The positive-sequence impedance Z1(f) 704 and zero-sequence impedance Z0(f) 703 are represented by the blocks on the right. They correspond to the system's balanced and unbalanced fault conditions, respectively. Inside the RLC equivalent circuit 705, the RLC components are configured to simulate the frequency-dependent response of the grid at specific resonant frequencies, with the inductors modeling the inductive characteristics of the system during transient events, and the overall impedance replicating the system's behavior under various operating conditions, including switching transients, faults, and harmonics. This arrangement allows for accurate simulations of the grid's performance without the complexity of the full-scale system.

After connecting the calculated values of RLC into the reduced electrical network, a system validation may be performed. System matching and validation of the frequency state between the large-scale transmission system and the reduced model are essential at the equivalency bus to ensure that the results from both systems match satisfactorily. The acceptable difference in results may, for example, be between 5% to 10%. Key parameters to validate include the voltage profile and fault currents for three-phase and single-phase-to-ground faults.

If any mismatch in the results occurs or when the validation fails, further fine-tuning of the model may be necessary to achieve accurate equivalency between the two systems. In one or more embodiments, the fine tuning may be achieved by adding more poles by repeating the steps of computing values of the one or more resistors, inductors, and capacitors at one or more resonant frequency poles from the plot and connecting the resistors, inductors, and capacitors with the computed values into the RLC equivalent system at the bus of equivalency, as described above.

Turning to FIG. 8, this figure is from the IEC-60071 standard. FIG. 8 illustrates the relationship between overvoltage types and their corresponding durations and frequencies. In one or more embodiments, FIG. 8 shows how different types of overvoltage events occur at varying timescales and frequency ranges in a power system. In other words, FIG. 8 is a typical range of transient overvoltage's and their corresponding frequencies ladder.

Key Overvoltage Types include Lightning Overvoltages, Switching Overvoltages, Temporary Overvoltages, and System Voltage.

Lightning Overvoltages (FFO) occur over microseconds (μs) and have a high-frequency range from 0.2 kHz to 10 MHz. The per-unit (p.u.) voltage can rise as high as 6 during these events.

Switching Overvoltages (SFO) occur over milliseconds (ms) with a frequency range between 0.2 kHz and 50 kHz. The voltage level is typically lower than lightning overvoltages but can still reach up to 4 p.u.

Temporary Overvoltages (TOV) overvoltages last for seconds(s) and have a lower frequency range, from 10 Hz to 3 kHz. The voltage during these events usually remains below 2 p.u.

System Voltage operates at a base voltage with a frequency of 50 or 60 Hz and remains steady under normal conditions.

It is important to note that steady-state values of Z1, Z2, and Z0 (calculated at 60 Hz) are not suitable for transient state simulations. During a transient state, the system's frequencies range from kHz to MHz, necessitating the use of frequency-dependent models for of Z1, Z2, and Z0 in both magnitude and phase. These models are required to accurately represent the electrical system and network topology behaviors during electromagnetic transient disturbances or switching phenomena.

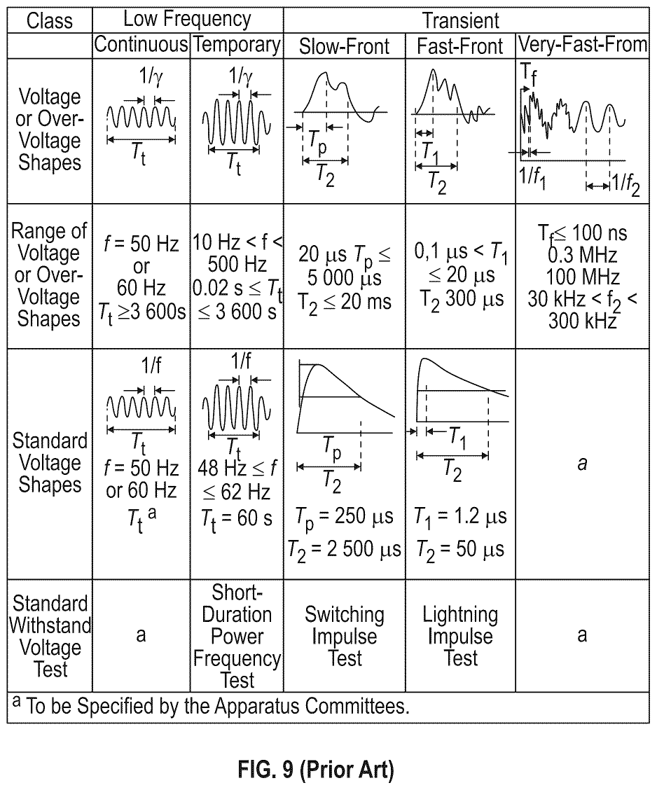

Turning to FIG. 9, this figure, also from the IEC 60071-1:2006 standard, classifies overvoltages into low-frequency and transient categories, each with specific voltage shapes, durations, and frequency ranges. Low-frequency overvoltages include continuous (50 or 60 Hz) and temporary overvoltages, while transient overvoltages are divided into slow-front, fast-front, and very-fast-front types. Each class is associated with specific voltage tests, such as the short-duration power frequency test for continuous overvoltages, switching impulse tests for slow-front transients, and lightning impulse tests for fast-front transients.

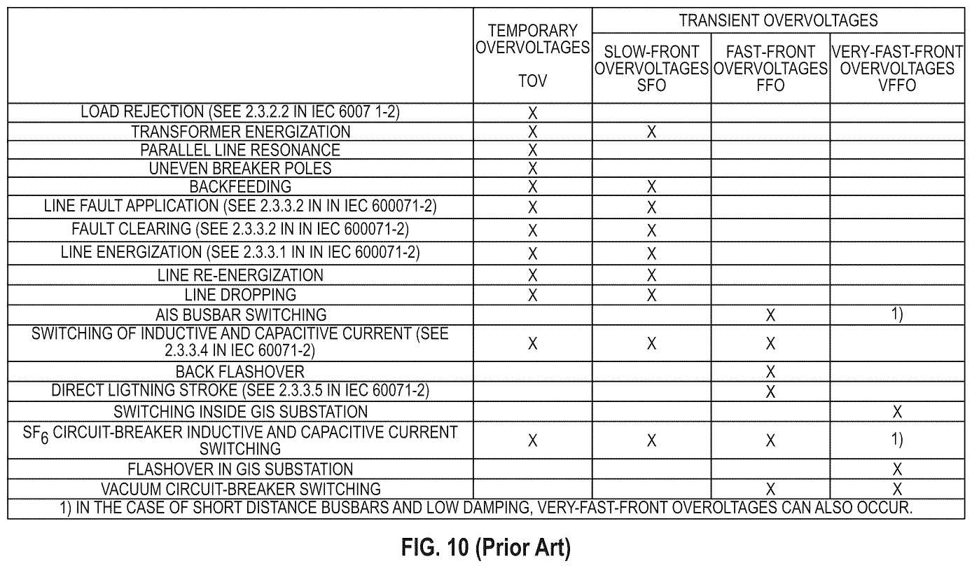

Turning to FIG. 10, this figure, also from the from the IEC 60071-1:2006 standard, categorizes the sources of various overvoltage types-temporary, slow-front, fast-front, and very-fast-front-based on common electrical events and system conditions. FIG. 10 highlights types of overvoltages likely to occur under specific scenarios such as load rejection, transformer energization, fault clearing, and circuit breaker switching.

Temporary Overvoltages (TOV) are primarily associated with events like load rejection, transformer energization, and parallel line resonance.

Slow-Front Overvoltages (SFO) are often caused by fault clearing, line energization, or switching inductive/capacitive currents.

Fast-Front Overvoltages (FFO) generally occur due to direct lightning strikes or back flashovers.

Very-Fast-Front Overvoltages (VFFO) are more likely in scenarios such as switching inside gas-insulated substations (GIS) or vacuum circuit breaker switching.

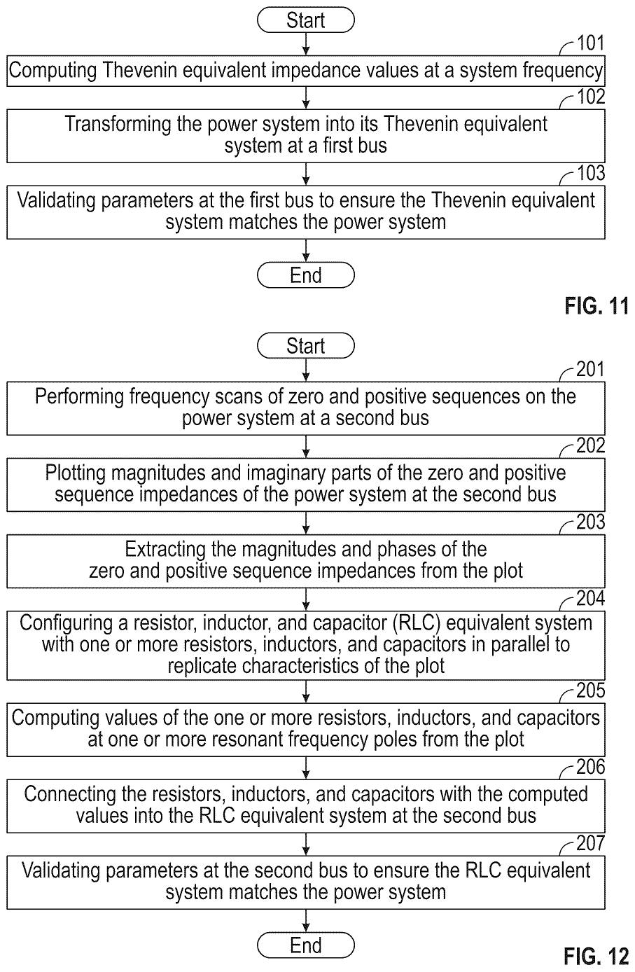

FIG. 11 is a flowchart that outlines a three-step process for computing and validating a Thevenin equivalent system for a power network.

In Step 101, the process begins with computing the Thevenin equivalent impedance values at a system frequency, which is essential for reducing the complexity of the power system model.

In this initial step 101, the Thevenin equivalent impedance of the power system is calculated at a specific system frequency, typically 50 Hz or 60 Hz, depending on the power network. The Thevenin impedance represents the simplified equivalent of a complex power system from a specific bus in the system.

Step 102: The power system is then transformed into its Thevenin equivalent at a specific bus, simplifying the system for further analysis.

Once the Thevenin equivalent impedance is computed in step 101, the following step 102 involves transforming the entire power system into its Thevenin equivalent at the specific bus. The Thevenin equivalent would include a single voltage source and a series impedance, which collectively replicate the behavior of the more complex network at that specific bus.

Step 103: Finally, parameters at the first bus are validated to ensure that the Thevenin equivalent system accurately matches the behavior of the actual power system.

In the final step 103, the accuracy of the Thevenin equivalent system is validated by comparing its behavior with that of the actual power system at the first bus. Key parameters to validate include voltage magnitude, phase angles, and impedance values. The validation process ensures that the Thevenin equivalent system behaves similarly to the full system under the same conditions. The validation is successful if the differences between the parameters of the full system and the Thevenin equivalent system are within an acceptable range, typically less than 5%. If the validation fails, adjustments may be made to the equivalent impedance or the transformation process to improve accuracy. This step 103 ensures that the reduced model can be used accurately and effectively for system analysis and simulations.

FIG. 12 is a flowchart that outlines the process for creating and validating an RLC equivalent system based on frequency scans at a second bus of the power network:

Step 201: Perform frequency scans of the zero and positive sequence impedances on the power system at the second bus.

In this initial step 201, a comprehensive frequency scan may be conducted on the power system at the second bus to determine how the zero-sequence and positive-sequence impedances vary with frequency. This involves applying a range of frequencies to the system and measuring the corresponding impedance values for both sequences. The purpose of this scan is to capture the frequency-dependent behavior of the system's impedances, which is critical for accurately modeling transient phenomena such as switching operations and fault conditions.

Step 202: Plot the magnitudes and imaginary parts of the zero and positive sequence impedances from the scan.

After obtaining the impedance data from the frequency scans, the next step 202 is to visualize this information by plotting it. The magnitudes and imaginary components of the zero and positive sequence impedances are plotted against frequency. These plots provide a graphical representation of how the impedances behave over the scanned frequency range. Peaks, dips, and trends in these plots can reveal resonant points of the system at different frequencies.

Step 203: Extract the magnitudes and phases of the zero and positive sequence impedances from the plots.

With the impedance plots prepared, specific data points are extracted for further analysis in step 203. This step involves determining the exact magnitudes and phase angles of the zero and positive sequence impedances at various frequencies, particularly at resonant peaks identified in the plots. The magnitudes provide information about the impedance levels, while the phases indicate whether the system is exhibiting inductive or capacitive behavior at those frequencies.

Step 204: Configure a resistor, inductor, and capacitor (RLC) equivalent system in parallel to replicate the characteristics of the plotted impedance behavior.

Using the extracted impedance data, an equivalent circuit including R, L, and C connected in parallel is configured. This RLC equivalent system is designed to mimic the frequency-dependent characteristics observed in the impedance plots. The parallel arrangement is particularly effective in replicating the “bell-shaped” resonance curves typical of power systems. By adjusting the values and configurations of the RLC components, the equivalent circuit can be tuned to closely match the impedance behavior of the original system across the frequency range of interest.

Step 205: Compute the values for one or more resistors, inductors, and capacitors from the identified resonant frequency poles in the plot.

In this step 205, precise values for the resistors, inductors, and capacitors in the RLC equivalent system are calculated. This may be achieved by analyzing the resonant frequency poles identified in the impedance plots—that is, the points where the system shows significant reactive behavior. Mathematical formulas relating frequency, impedance, and component values are used to compute the necessary R, L, and C values that will replicate the observed impedance characteristics at these resonant frequencies.

Step 206: Connect the computed resistor, inductor, and capacitor values into the RLC equivalent system at the second bus.

Once the component values have been calculated, they are integrated into the RLC equivalent system at the second bus in the step 206. This involves physically or virtually connecting the resistors, inductors, and capacitors with their computed values in a parallel configuration. By doing so, the equivalent circuit becomes a functional model that represents the frequency-dependent impedance behavior of the power system at the second bus.

Step 207: Validate the parameters of the RLC equivalent system at the second bus to ensure that it matches the behavior of the original power system.

The final step 207 involves validating the accuracy and reliability of the RLC equivalent system. This may be done by comparing the performance of the equivalent circuit with that of the original power system at the second bus under similar conditions. Key parameters such as voltage profiles, impedance responses, and fault currents may be analyzed to assess the equivalency. If the results from the equivalent system closely match those of the original system within acceptable margins (e.g., a difference of less than 10%), the validation is considered successful. If discrepancies are found, adjustments to the RLC component values may be necessary. This validation ensures that the simplified model can reliably be used for transient analysis and other studies without significant loss of accuracy.

This method with the above steps 201-207 ensures that the RLC equivalent system accurately represents the frequency-dependent behavior of the power system.

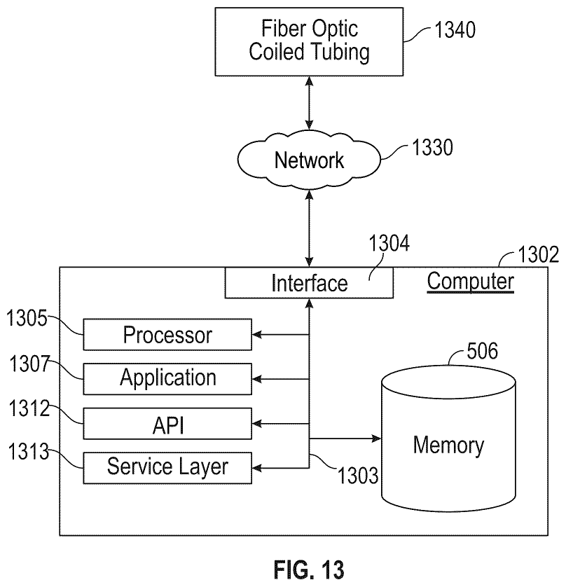

Turning to FIG. 13, embodiments of the invention may be implemented on a computer system. The implementation of this new method can be executed using a computer system. A non-transitory computer-readable medium containing instructions, when executed by a processor such as in computer 1302, causes the processor to carry out steps that include performing frequency scans of zero and positive sequence impedances on a power system at a bus, plotting magnitudes and imaginary parts of the zero and positive sequence impedances, and extracting the magnitudes and phases of the impedances from the plot. The system then configures a resistor, inductor, and capacitor (RLC) equivalent system in parallel to replicate the characteristics of the impedance plot, computes values for the components at resonant frequency poles, connects the components into the RLC equivalent system, and validates the parameters at the bus to ensure the RLC system matches the power system. This method may be implemented on a cloud computing system, utilizing one or more service models such as infrastructure as a service (IaaS) or artificial intelligence as a service (AIaaS).

FIG. 13 shows a block diagram of a computer system 1302 used to provide computational functionalities associated with described ML (ML) models, methods, functions, processes, flows, and procedures as described in the instant disclosure, according to an implementation. The illustrated computer 1302 is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1302 may include a computer that includes an input device, such as a keypad, keyboard, touch screen, or other device that can accept user information, and an output device that conveys information associated with the operation of the computer 1302, including digital data, visual, or audio information (or a combination of information), or a GUI.

The computer 1302 can serve in a role as a client, network component, a server, a database or other persistency, or any other component (or a combination of roles) of a computer system for performing the subject matter described in the instant disclosure. The illustrated computer 1302 is communicably coupled with a network 1330. In some implementations, one or more components of the computer 1302 may be configured to operate within environments, including cloud-computing-based, local, global, or other environment (or a combination of environments).

At a high level, the computer 1302 is an electronic computing device operable to receive, transmit, process, store, or manage data and information associated with the described subject matter. According to some implementations, the computer 1302 may also include or be communicably coupled with an application server, e-mail server, web server, caching server, streaming data server, business intelligence (BI) server, or other server (or a combination of servers).

The computer 1302 can receive requests over network 1330 from a client application (for example, executing on another computer 1302) and responding to the received requests by processing the said requests in an appropriate software application. In addition, requests may also be sent to the computer 1302 from internal users (for example, from a command console or by other appropriate access method), external or third-parties, other automated applications, as well as any other appropriate entities, individuals, systems, or computers.

Each of the components of the computer 1302 can communicate using a system bus 1303. In some implementations, any or all of the components of the computer 1302, both hardware or software (or a combination of hardware and software), may interface with each other or the interface 1304 (or a combination of both) over the system bus 1303 using an application programming interface (API) 1312 or a service layer 1313 (or a combination of the API 1312 and service layer 1313. The API 1312 may include specifications for routines, data structures, and object classes. The API 1312 may be either computer-language independent or dependent and refer to a complete interface, a single function, or even a set of APIs. The service layer 1313 provides software services to the computer 1302 or other components (whether or not illustrated) that are communicably coupled to the computer 1302. The functionality of the computer 1302 may be accessible for all service consumers using this service layer. Software services, such as those provided by the service layer 1313, provide reusable, defined business functionalities through a defined interface. For example, the interface may be software written in JAVA, C++, or other suitable language providing data in extensible markup language (XML) format or other suitable format. While illustrated as an integrated component of the computer 1302, alternative implementations may illustrate the API 1312 or the service layer 1313 as stand-alone components in relation to other components of the computer 1302 or other components (whether or not illustrated) that are communicably coupled to the computer 1302. Moreover, any or all parts of the API 1312 or the service layer 1313 may be implemented as child or sub-modules of another software module, enterprise application, or hardware module without departing from the scope of this disclosure.

The computer 1302 includes an interface 1304. Although illustrated as a single interface 1304 in FIG. 13, two or more interfaces 1304 may be used according to particular needs, desires, or particular implementations of the computer 1302. The interface 1304 is used by the computer 1302 for communicating with other systems in a distributed environment that are connected to the network 1330. Generally, the interface 1304 includes logic encoded in software or hardware (or a combination of software and hardware) and operable to communicate with the network 1330. More specifically, the interface 1304 may include software supporting one or more communication protocols associated with communications such that the network 1330 or interface's hardware is operable to communicate physical signals within and outside of the illustrated computer 1302.

The computer 1302 includes at least one computer processor 1302. Although illustrated as a single computer processor 1302 in FIG. 13, two or more processors may be used according to particular needs, desires, or particular implementations of the computer 1302. Generally, the computer processor 1302 executes instructions and manipulates data to perform the operations of the computer 1302 and any ML models, methods, functions, processes, flows, and procedures as described in the instant disclosure.

The computer 1302 also includes a memory 1305 that holds data for the computer 1302 or other components (or a combination of both) that can be connected to the network 1330. For example, memory 1305 can be a database storing data consistent with this disclosure. Although illustrated as a single memory 1305 in FIG. 13, two or more memories may be used according to particular needs, desires, or particular implementations of the computer 1302 and the described functionality. While memory 1305 is illustrated as an integral component of the computer 1302, in alternative implementations, memory 1305 can be external to the computer 1302.

The application 1307 is an algorithmic software engine providing functionality according to particular needs, desires, or particular implementations of the computer 1302, particularly with respect to functionality described in this disclosure. For example, application 1307 can serve as one or more components, modules, applications, etc. Further, although illustrated as a single application 1307, the application 1307 may be implemented as multiple applications 1307 on the computer 1302. In addition, although illustrated as integral to the computer 1302, in alternative implementations, the application 1307 can be external to the computer 1302.

There may be any number of computers 1302 associated with, or external to, a computer system containing computer 1302, each computer 1302 communicating over network 1330. Further, the term “client,” “user,” and other appropriate terminology may be used interchangeably as appropriate without departing from the scope of this disclosure. Moreover, this disclosure contemplates that many users may use one computer 1302, or that one user may use multiple computers 1302.

In some embodiments, the computer 1302 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

The implementation of this new method as discussed above will significantly benefit small and medium enterprises (SMEs) involved in developing, conducting, or reviewing Advanced Power System Studies (APSS). Key advantages include reduced time and system modeling size while maintaining accuracy. Time savings are estimated at 30% to 60%, providing a substantial competitive edge to companies and consulting firms through cost avoidance and savings. For large programs and projects, where APSS and Insulation Coordination Studies are mandatory, the method ensures the correctness of Thevenin equivalent modeling for transient states and facilitates system modeling reduction from large-scale networks to smaller, more compact systems. This approach offers a significant improvement over current practices, especially in terms of transient state analysis and overall system modeling efficiency.

The key advantages of the method are its ability to reduce the size of power system models, enable adequate system equivalency for transient simulations, and provide compact transmission system input data while preserving accurate results. The method also offers time reductions of 30% to 60%, depending on the system's complexity, giving a significant competitive edge to companies and consulting firms.

Embodiments disclosed herein reduce the complexity of power system modeling by enabling accurate system equivalency and compact representation. Embodiments disclosed herein further significantly simplify the simulation process for both steady-state and transient-state analyses, and at the same time ensure faster execution and more efficient resource utilization.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for reducing complexity of a power system, comprising:
performing frequency scans of zero and positive sequence impedances on the power system at a bus;
plotting magnitudes and imaginary parts of the zero and positive sequence impedances of the power system at the bus;
extracting the magnitudes and phases of the zero and positive sequence impedances from the plot;
configuring a resistor, inductor, and capacitor (RLC) equivalent system with one or more resistors, inductors, and capacitors in parallel to replicate characteristics of the plot;
computing values of the one or more resistors, inductors, and capacitors at one or more resonant frequency poles from the plot; and
connecting the computed values into the RLC equivalent system at the bus.

2. The method of claim 1, further comprising:
validating parameters at the bus to ensure the RLC equivalent system matches the power system.

3. The method of claim 1, wherein the power system is in a transient state.

4. The method of claim 2, wherein the parameters to be validated include a voltage profile.

5. The method of claim 4, wherein the parameters to be validated include three-phase fault and single-phase-to-ground fault.

6. The method of claim 2, wherein the validation succeeds if a difference between parameter values in the power system and the RLC equivalent system is smaller than 10%.

7. The method of claim 6, wherein when validation fails, steps of computing the values of R, L, and C and connecting the computed R, L, C values are repeated.

8. The method of claim 1, wherein the power system is a large-scale transmission network.

9. The method of claim 1, wherein the impedance plots show a peak impedance at specific resonant frequencies, followed by a decline as frequencies shift away from the specific resonant frequencies.

10. The method of claim 1, wherein the RLC equivalent system simulates switching transients, inrush transients, and harmonic phenomena.

11. The method of claim 1, wherein the frequency scans cover a range of frequencies from KHz to MHz.

12. The method of claim 3, wherein responsive to the power system transitioning from the transient state to a steady state, the method further comprises:
computing Thevenin equivalent impedance values at a system frequency;
transforming the power system into its Thevenin equivalent system at the bus; and
validating parameters at the bus to ensure the Thevenin equivalent system matches the power system.

13. The method of claim 12, wherein the parameters to be validated include voltage magnitude and phase.

14. The method of claim 12, wherein the parameters to be validated include three-phase fault and single-phase-to-ground fault.

15. The method of claim 12, wherein the parameters to be validated include active and reactive power and flow directions.

16. The method of claim 12, wherein validation succeeds if a difference between parameter values in the power system and the Thevenin equivalent system is smaller than 5%.

17. The method of claim 12, wherein the system frequency is 60 Hz or 50 Hz.

18. A non-transitory computer-readable medium containing instructions that, when executed by a processor, cause the processor to carry out steps that include:
performing frequency scans of zero and positive sequence impedances on a power system at a bus;
plotting magnitudes and imaginary parts of the zero and positive sequence impedances of the power system at the bus.
extracting the magnitudes and phases of the zero and positive sequence impedances from the plot;
configuring resistor, inductor, and capacitor (RLC) equivalent system with one or more resistors, inductors, and capacitors in parallel to replicate characteristics of the plot;
computing values of the one or more resistors, inductors, and capacitors at one or more resonant frequency poles from the plot;
connecting the resistors, inductors, and capacitors with the computed values into the RLC equivalent system at the bus; and
validating parameters at the bus to ensure the RLC equivalent system matches the power system.
